(19) United States
(12) Patent Application Publication
(10) Pub. No.: US 2003/0173304 A1
(43) Pub. Date: Sep. 18, 2003

(54) Fluid treatment apparatus

(76) Inventors: Christopher Michael David Joslin, Dorchester (GB); John Christopher Sutherland Buchanan, Verwood (GB)

Correspondence Address: B. Noel Kivlin, Conley, Rose, & Tayon, P.C., P.O. Box 398, Austin, TX, 78767, US

(21) Appl. No.: 10/150,641

(22) Filed: May 16, 2002

(30) Foreign Application Priority Data
Mar. 15, 2002 (GB) 0206178.6

(51) Int. Cl. C02F 1/52

(52) U.S. Cl. 210/702; 210/205; 210/287

(57) ABSTRACT

Disclosed is an environmentally friendly fluid treatment assembly comprising: a back-flushable filter, a fluid conditioning device and a control valve. During normal operation, fluid is directed by the control valve to pass through the conditioning device wherein the precipitation of solids dissolved within the fluid takes place. The fluid is then directed to flow through a filter medium within the back-flushable filter where precipitates and other solids are removed from the flow. The fluid then exits the assembly via the control valve. During back-flushing, the direction of fluid flow through the assembly is reversed and the filter medium is fluidised while precipitates and other solids are flushed out of the filter through the control valve. The assembly finds particular but not exclusive application to the treatment of water. Water treatment devices comprising an embodiment of the present invention lead to the precipitation of carbonates from hard water and removes those precipitates from the water flow. This enhances the ability of the assembly to produce treated water which is capable of absorbing previously formed scale deposits within a water system while preventing any significant accumulation of additional scale. Since the conditioning device does not make use of ion exchange resins, back-flushing does not require the use of a brine solution.

### FIELD OF THE INVENTION

The present invention relates to the treatment of fluids. The invention finds particular but not exclusive application in the field of water treatment. The invention finds particular but not exclusive use in domestic water supplies as well as in large scale industrial applications.

### BACKGROUND ART

It is well known that hardness comprising carbonates and bicarbonates of calcium and magnesium presents a number of problems for the consumption of and/or the use of water. Examples of these problems are: the production of a soap scum during cleaning which adheres to the surfaces of the washed articles and which is difficult to remove, the subjectively unpalatable taste of hard water when used for drinking, and in particular, the formation of scale deposits within water systems, especially in cases where the water is heated.

Water softening devices which make use of an ion exchange reaction are common in the field of water treatment. Devices of this kind typically comprise a tank filled with a mineral or an ion exchange resin through which hard water is passed. During the ion exchange process, hard water ions such as magnesium and calcium bond ionically with the resin and are thereby removed from the water to be replaced with sodium ions. After a given period of use, the softener will tend to become saturated with hard water ions. When this occurs, it is possible to regenerate the softener by flushing it with a strong solution of salt water (brine). This removes the hard water ions from the resin and replaces them with sodium ions, thereby replenishing the resin bed. Following this, the softener is rinsed to remove any remaining salt.

One drawback of devices such as these is that the regeneration process requires the use of a substantial amount of salt. While some of the sodium ions are of course retained within the softener during flushing, much of the salt is not used in the regenerating process and subsequently passes out through the drain. As a consequence, the flushing of water softening devices of this type inevitably leads to the release of a considerable amount of salt into the environment, particularly in the case of large-scale industrial applications. The pollution of water supplies in this manner is a growing problem, especially in the case of potable water supplies whereby any significant quantity of salt in the water can render it undrinkable. Since sodium chloride is not efficiently and economically removable from water, sewage treatment plants tend to allow any rise in the level of salt in the water supply to go unchecked.

Hardness in water arises from two separate sources, these are labelled according to the time scales over which they tend to appear. Temporary hardness arises principally from bicarbonates of calcium and magnesium whereas permanent hardness arises from carbonates of the above bases. In a given quantity of hard water, permanent hardness is typically present in far greater quantities than temporary hardness. The bicarbonates forming temporary hardness are relatively soluble in water but can decompose into the relatively insoluble carbonates forming permanent hardness under the application of heat through following reaction:

Ca(HCO₃)₂=CaCO₃+CO₂+H₂O

Since hard water is typically saturated with the magnesium and calcium carbonates forming permanent hardness, the above reaction, wherein additional carbonates are formed, will tend to lead to precipitation of those carbonates. The above reaction is responsible for the formation of scale deposits in water systems, particularly for those systems in which the water is heated.

From these considerations it is apparent that the selective removal of bicarbonates from hard water would be more effective than the removal of carbonates in the prevention of scale formation. That is to say, if all magnesium and calcium bicarbonates were removed from a quantity of hard water, the reaction given above would no longer lead to the formation of scale deposits. Subsequently, alternative methods of water treatment are available which involve the use of resins which selectively remove the bicarbonates from hard water. However, although these methods are suitable for the treatment of small quantities of water they are, for various technical and economic reasons, unviable for the treatment of larger quantities thereof. Additionally, this method has the undesirable effect of releasing chlorides into the water in much the same way that sodium is released using the more traditional types of resin discussed above. Furthermore, resins which operate in this manner are also prone to saturation and require regeneration through the application of a strong saline solution.

Back-flushing filters are presently common in the water treatment industry for the filtering of a continuous flow of water. These filters comprise one or more vessels containing a filter medium for removing solids from the flow of water. Filters such as these are back-flushable in order that the solids that have become trapped in the filter media be removed. This avoids the clogging of the filter with excess trapped materials, which can lead to a substantial drop in pressure at the filter outlet. More than one such vessel can be provided so that back-flushing can occur without halting the flow of water.

An alternative type of water conditioner which does not require regeneration through brine flushing, is described in European Patent 680457 B2. This type of device employs a combination of dielectric and conductive channels with chambers in which turbulent flow of water is encouraged. Tests have proven that this type of device causes the precipitation and conglomeration of calcium carbonate particles in a flow of hard water. These particles are then able to act as nucleation sites for the further precipitation of carbonates. Since water flowing from the device is relatively weakly saturated in these hard water ions, which form permanent hardness, the addition of carbonates to the water through, for instance the reaction given above is less likely to lead to precipitation. As a consequence, water treated in this manner is less likely to give rise to the build up of scale deposits in water systems. Furthermore, water which is relatively unsaturated in carbonates should be able to reabsorb previously formed precipitates. It would therefore appear that this water conditioning device can actually lead to the absorption and breaking up of old scale deposits.

However, with this kind of device, the precipitated carbonate particles remain within the flow of water after passing through the conditioner. Since, as mentioned above, water flowing from the conditioner is able to absorb precipitates/scale, this implies that the precipitates formed within the device could eventually be reabsorbed. This leads to a “memory effect” in which the degree of softness and the ability of the treated water to remove old scale deposits generally degrades as the water moves downstream of the device.

### SUMMARY OF THE INVENTION

An aspect of the invention provides a treatment apparatus for treating a fluid containing dissolved compounds, the treatment assembly comprising:

a fluid conditioning device operable to stimulate the precipitation of at least some of the dissolved compounds as precipitates;

a vessel containing a filter medium operable to trap said precipitates; and

a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium.

The invention addresses the problems indicated above since the precipitates which are removed from the flow of water are not available for reabsorption as the water moves downstream of the device. This improves the ability of the water to reabsorb previously formed scale deposits in the manner described above while avoiding the formation of additional deposits. The invention is also advantageous in the case of potable water supplies since the precipitates removed from the water may otherwise prove unsightly to the drinker. Furthermore, the assembly is back-flushable and is therefore not prone to excessive build up of precipitated particles or other solids within the filter. The assembly is, in use, also environmentally friendly since effective back-flushing of the filter does not require the use of brine.

The invention also provides a means for the removal from fluid of other dissolved substances such as iron compounds and also for the removal of suspended particles/colloids from fluid such as proteins found in swimming pool water. The apparatus eases the removal of these substances since the preciptation/coagulation effect produced by the fluid treatment device leads to larger particles which may be filtered out more effectively.

Another aspect of the invention provides a fluid conditioning device configured to be located around a tubular member, the fluid conditioning device comprises a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel, and the fluid conditioning device being configured to stimulate turbulence of the fluid when passing through said channels.

A further aspect of the invention provides a method of treating a fluid containing dissolved compounds, the method comprising:

passing the fluid through a fluid conditioning device operable to stimulate the precipitation of at least some of the dissolved compounds as precipitates;

trapping the precipitates in filter medium within a vessel; and

periodically back-flushing the filter medium to remove said precipitates from the filter medium.

Yet another aspect of the invention provides a fluid conditioning device configured to be located around a tubular member, the fluid conditioning device comprising:

a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel;

electrically conductive inner and outer annular walls, which electrically conductive walls are electrically connected; and

an annular passage defined between the inner annular wall and the outer annular wall, wherein the channel defining members are located within the inner annular wall, said metallic channel defining members are electrically connected to the inner annular wall, the inner and outer annular walls comprise of a first metal and the metallic channel defining members comprise a second metal that forms a sacrificial anode with respect to the first metal.

Yet another aspect of the invention provides a fluid conditioning device configured to be located around a tubular member, the fluid conditioning device comprising:

a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel, and the fluid conditioning device being configured to stimulate turbulence of the fluid when passing through said channels;

an inner annular wall;

an outer annular wall, the channel defining members being located within the inner annular wall; and

an annular passage defined between the inner annular wall and the outer annular wall, wherein the inner and outer annular walls comprise of a first metal and the at least one metallic channel defining member comprises a second metal that forms a sacrificial anode with respect to the first metal, and least some of the channel defining members are configured to stimulate turbulence.

Yet another aspect of the invention provides a treatment apparatus for treating a fluid containing dissolved compounds, the treatment assembly comprising:

a fluid conditioning device operable to stimulate the precipitation of at least some of the dissolved compounds as precipitates;

a vessel containing a filter medium operable to trap said precipitates;

a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium,

wherein said fluid conditioning device comprises:

a plurality of channel defining members arranged sequentially between first and second ends of said fluid conditioning device, which channel defining members include at least one metallic channel defining member and at least one dielectric channel defining member, each channel defining member defining at least one channel, said fluid conditioning device being configured to stimulate turbulence of the fluid when passing through said channels.

Yet another aspect of the invention provides a treatment apparatus for treating a fluid containing dissolved compounds, the treatment assembly comprising:

a fluid conditioning device, operable to stimulate the precipitation of at least some of the dissolved compounds as precipitates;

a vessel containing a filter medium operable to trap said precipitates;

a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium; and

a riser tube in fluid communication with a lower portion of said vessel, said riser tube extends said lower portion of the vessel to an opening in said vessel at an upper portion of the vessel, wherein said fluid conditioning device is in fluid communication with an upper portion of said vessel.

Yet another aspect of the invention provides a fluid treatment device comprising:

a fluid conduit;

a fluid conditioning device configured to be mounted around said fluid conduit;

a cavity containing a filter medium; and

means for switchably directing a flow of fluid though said fluid treatment device according to either of two modes of operation, wherein in the first mode of operation, said flow of fluid is directed through said fluid conditioning device whereby the precipitation of at least some dissolved compounds contained within said fluid is stimulated, the fluid then passes through said filter medium whereby said precipitates are removed from said flow of fluid, said fluid then passes out of said fluid treatment device through said fluid conduit, in the second mode of operation, the direction of fluid flow is substantially reversed whereby said filter medium is back-flushed to remove said precipitates from said filter medium.

Yet another aspect of the invention provides fluid conditioning means configured to be located around a tubular member, the fluid conditioning means comprising:

at least one metallic channel defining means, each defining at least one metallic channel;

at least one dielectric channel defining means each defining at least one dielectric channel; the channel defining means have an annular form to fit around the tubular member and the channel defining means are arranged sequentially between first and second ends of the fluid conditioning means, the fluid conditioning means being configured to stimulate turbulence of the fluid when passing through said channels.

Yet another aspect of the invention provides fluid treatment means for treating a fluid containing dissolved compounds, comprising:

fluid conditioning means operable to stimulate the precipitation of at least some of the dissolved compounds as precipitates;

filter means operable to trap said precipitates; and

valve means operable to direct a flow of fluid through said means for treating a fluid according to either of two modes of operation, wherein in said first mode of operation fluid to be treated is passed via said fluid conditioning means into said filter means, and in said second mode of operation, the direction of flow through said fluid treatment means is substantially reversed, thereby back-flushing said filter means to remove said precipitates therefrom.

Yet another aspect of the invention provides a method for treating fluid containing dissolved compounds, the method comprising steps of:

stimulating turbulent flow in the fluid;

passing the fluid through a filter medium, whereby precipitates of the dissolved compounds present in the fluid are retained in the filter medium;

periodically flushing the filter medium whereby at least some of the precipitates retained in the filter medium are removed therefrom.

Yet another aspect of the invention provides a method for treating fluid containing dissolved compounds, the method comprising steps of:

passing the fluid through one or more channels configured to stimulate the precipitation of the dissolved compounds;

passing the fluid through a filter medium, whereby at least some of the precipitates are retained in the filter medium;

periodically flushing the filter medium whereby at least some of the precipitates retained in the filter medium are removed therefrom.

### BRIEF DESCRIPTION OF THE DRAWINGS

Embodiments of the invention will now be described hereinafter, by way of example only, with reference to the accompanying drawings where reference signs relate to like elements and in which:

FIG. 1 is a cross sectional view of a water treatment assembly in accordance with one embodiment of the present invention;

FIG. 2 is a perspective view of the spreader which forms part of the water treatment assembly shown in FIG. 1;

FIG. 3 is a cross sectional view of the water conditioning device which may be incorporated into the water treatment assembly shown in FIG. 1;

FIG. 4 is a cut away view of the water conditioning device shown in FIG. 2.

### DETAILED DESCRIPTION OF THE INVENTION

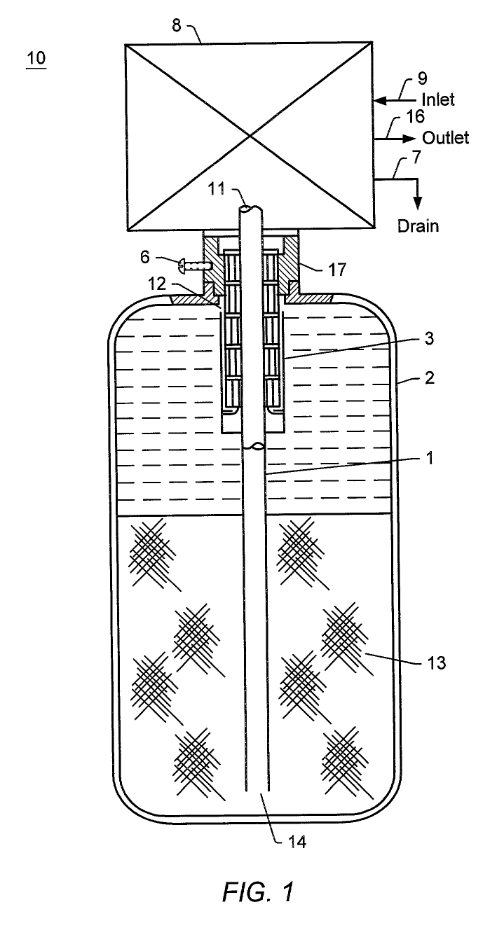

The assembly 10, embodiments of which are shown in FIGS. 1 to 4, comprises a back-flushable filter comprising a pressure vessel 2 or tank which contains a filter medium 13, a riser tube 1 which can be inserted through an opening in the pressure vessel 2, a conditioning device 3 which is mounted in fluid communication the pressure vessel 2 and a control valve 8 having a plurality of ports for providing fluid communication between the other elements of the assembly 10.

The pressure vessel 2 can be manufactured from, for example, glass reinforced plastics (fibre glass), or from any other suitable non-conductive (e.g. plastics) or conductive (e.g. metal) material. The vessel 2 is provided with a one more openings for connection to further elements of the treatment assembly 10 such as the riser tube 1, the fluid conditioning device 3 or to further piping. The pressure vessel 2 is partially filled with a filter medium 13 which can, for example, comprise fine sand or another suitable material such as manganese green sand or BIRM. The filter medium 13 should preferably be denser than the fluid which it filters such that it settles to the bottom of the pressure vessel 2. The level to which the pressure vessel 2 is filled with the filter medium 13 can be chosen to suit specific design requirements.

The riser tube 1 can be constructed from any suitable material, for example plastics, copper, aluminium etc., and passes, in use, through an opening in the pressure vessel 2. It is connected at one end (hereinafter referred to as the upper end) outside the pressure vessel to the control valve 8, while the other end (hereinafter referred to as the lower end) is located, in use, in the pressure vessel 2. The riser tube 1 should be mounted such that the lower end lies below the surface of the filter medium 13, near or in the lower region of the pressure vessel 2. At the lower end of the riser tube 1, a spreader 14 can be provided. The spreader 14 can be formed integrally with the riser tube 1 or can comprise a separate element which is attachable to the lower end of the riser tube 1. The spreader 14 comprises a section of tubing in which one or more holes 15 are formed such that fluid can flow from the riser tube 1 to the pressure vessel 2 and vice versa. These holes 15 should be completely immersed beneath the top level of the filter medium 13.

The control valve 8 comprises a fluid inlet 9 and a fluid outlet 16 for the integration of the fluid treatment assembly 10 into a system such as a water system. A further drain outlet 7 is provided for use during back-flushing; this will be described in more detail below. Additional ports (outlets/inlets) are provided for connection to the riser tube 1 and to the fluid conditioning device 3.

The fluid conditioning device 3 has an inlet 11 which is in fluid communication with the control valve 8 and an outlet 12 which is in fluid communication with the pressure vessel 2. The device can make use of a separate opening in the pressure vessel 2 to that through which the riser tube 1 is mounted or alternatively the device 3 and the riser tube 1 may connect with the pressure vessel 2 by means of a common opening. The device 3 may be mounted partially within the pressure vessel 2 or may be located elsewhere within the assembly 10, provided that the necessary connections are formed in accordance with those described herein.

The operation of the fluid treatment assembly will now be described with reference to the embodiments shown in FIGS. 1 to 4. These embodiments refer in particular to the case where the assembly is inserted into a water system for the treatment of water.

FIG. 1 shows a particular embodiment of the fluid treatment assembly in accordance with the present invention. In this embodiment, the riser tube 1 is vertically mounted through an opening at the top of the pressure vessel 2. Although this arrangement is preferable, it will be appreciated that other arrangements may suffice. Both the riser tube 1 and the conditioning device 3 make use of the same opening for fluid communication with the pressure vessel 2. In this embodiment, the conditioning device 3 is designed to be mountable upon the riser tube 1 in a sleeve like manner. The conditioning device 3 is further mountable upon the pressure vessel 2 by means of a screw thread 4a provided at the pressure vessel opening and its corresponding thread 4b on the brass block 5. The brass block 5 is optionally provided with an earth connection 6 for connection to an external earth.

During normal operation of the assembly 10, the drain outlet 7 at the control valve 8 is closed. Fluid flows into the control valve 8 via the inlet 9 and is directed to the inlet 11 of the conditioning device 3 in this embodiment. The outlet 12 of the conditioning device 3 is located in close proximity to the upper region of the pressure vessel 2. The pressure vessel 2 is typically only partially filled with the filter media 13. Fluid flowing from the conditioning device 3 subsequently passes through the filter media 13 and any precipitates or other colloids contained within the flow are trapped within the filter. The water then passes into the riser tube 1 via the spreader 14. The spreader 14 is located at the lower end of the riser tube. Holes 15 are provided at the sides of the spreader 14. While these holes 15 allow water to pass into the riser tube 1, they present a barrier to the filter media 13. This prevents the loss of filter media 13 from the assembly 10. Fluid entering the riser tube 1 then flows upwards under pressure and enters the control valve 8 from where it is directed to the control valve outlet 16.

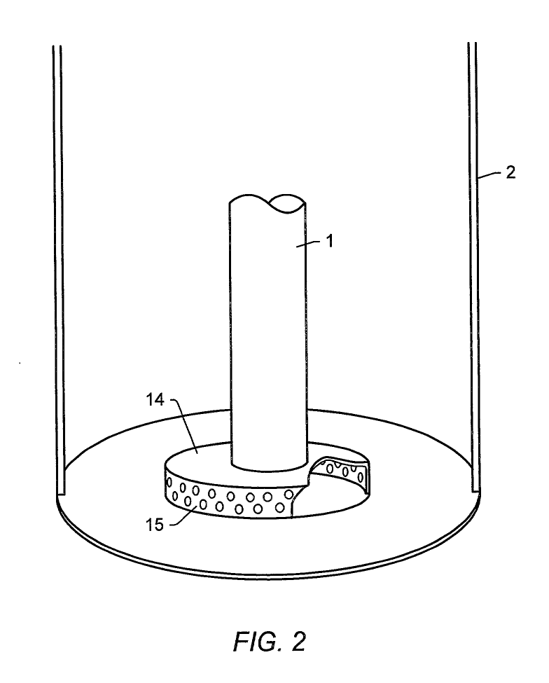

During back-flushing, the outlet 9 of the control valve 8 is closed and the drain outlet 7 is opened. Fluid entering the control valve 8 via the inlet 9 is directed to flow into the riser tube 1. At the lower end of the riser tube 1, the water is forced (under pressure) to pass through the holes 15 provided in the spreader 14 and into the filter media 13. This has the effect of loosening and fluidising the filter media 13. At this stage, the configuration of the holes 15 provided at the spreader 14 assist in the loosening and fluidising process. An embodiment of the spreader showing possible configurations for these holes 15 is shown in FIG. 2. Back-flushing in this manner helps to prevent any aggregation of the filter media 13 which may otherwise occur over long periods of use.

Having passed through the filter media 13, the fluid then enters the outlet 12 of the conditioning device 3 and passes out of the treatment assembly 10 via the drain outlet 7. In loosening the filter media 13, the back flow of water also has the effect of dislodging and carrying away the precipitates or other solids that have collected in the filter media 13 over a period of normal operation.

At this stage, the separation of the outlet 12 from the filter media 13 and the higher density of the filter media 13 with respect to the fluid, aids to prevent the loss of media 13 via the conditioning device 3.

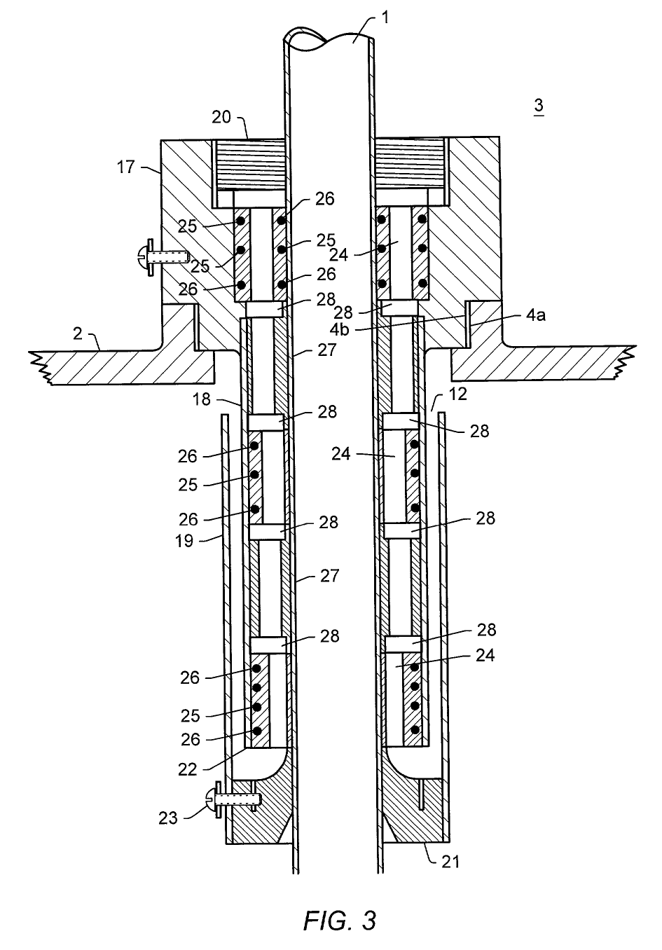

FIG. 3 is a cross sectional view of the conditioning device 3 used in accordance with the particular embodiment of the invention shown in FIG. 1. A perspective view of this same embodiment is shown in FIG. 4. The conditioning device 3 comprises:

a brass block 17 with an external earth connection 6 and a screw thread 20 which provides connection means for connection to the control valve 8 either directly or via further piping;

an inner annular wall 18 and an outer annular wall 19 made of brass which surround the riser tube 1;

a PTFE end member 21 upon which the outer annular wall 19 may be mounted 1; and

a plurality of channel defining members arranged sequentially along the length of the water conditioning device 3 which define channels for the flow of liquid between the inlet 11 and the outlet 12.

The brass block 17 is substantially ring shaped. The upper portion of the inner surface of the ring and forms the inlet 11 of the water conditioning device 3 and can be provided with a thread 20 for connection to the control valve 8. A second thread 4b can be provided for mounting the block 17 to the opening in the pressure vessel 2.

In this particular embodiment, the external earth connection 6 comprises a screw 6 inserted into the outer surface of the brass block 17 to which wires can be attached. The block 17 also provides support and mounting means for other elements of the conditioning device 3.

The inner annular wall 18 can be welded to the inner surface of the lower portion of the brass block 17. The inner annular wall 18 also provides a housing for the channel defining members. The inner annular wall 18 is further attached to the PTFE end member 21. The portion of the inner annular wall 18 which spans the region between the lowermost channel defining member and the PTFE end member 21, is provided with a series of holes 22 in order that fluid can flow between the outlet 12 and the channels defined by the lowermost channel defining member.

The outer annular wall 19 is mounted on the PTFE end member 21. The mounting can be provided by an adhesive or by any other suitable means. A screw 23 or other connection means is provided for electrical contact between the inner 18 and outer 19 annular walls. The screw can also assist in preventing relative movement between the inner 18 and outer 19 annular walls. When the conditioning device 3 is mounted, the outer annular wall 19 extends from the bottom of the device 3 up towards the top of the pressure vessel 2 and provides a vertically orientated, annular channel for fluid flow. The upper end of this channel forms the outlet 12 of the conditioning device 3. This channel aids in the separation of the outlet 12 from the top level of the filter medium 13.

In alternative embodiments, other construction materials can be used for the inner 18 and outer 19 annular walls for example plastics, aluminium or another metal.

There are essentially two fundamental types of channel present in the water conditioning device 3, these are distinguished in part by the material which is used to define them. The channels are located within the annular cavity which is defined by the outer surface of the riser tube 1 and the inner surface of the brass block 17 or the inner surface of the inner annular wall 18. This annular cavity is partially filled with a series of annularly shaped channel defining members, each constructed from a given material. In the embodiment shown in FIGS. 3 and 4, some members are manufactured from zinc and some from a dielectric material such as PTFE. It will be clear to the skilled person that different sequences or combinations of these different types of channel defining members can be used in accordance with particular design requirements. Each channel defining member is perforated by an array of bore holes made parallel with the long axis of the riser tube 1 and which form the above mentioned channels. When the channel defining members are installed within the annular cavity, the bore holes of each member can be aligned to correspond to the bore holes in neighbouring members. In the embodiment shown in FIGS. 3 and 4 however, the bores are deliberately misaligned, the reason for this misalignment will be described below.

The purpose of both types of channel will now be described in relation to the embodiment shown in FIGS. 3 and 4.

The walls of the channels formed within the zinc members 24 act as sacrificial anodes for the conditioning device 3 as well as for the neighbouring pipe network with which the assembly 10 is integrated. It will be noted that in the embodiment shown in FIGS. 3 and 4, each zinc member 24 is provided with at least one dry 25 contact to either the brass block 17 or to the inner annular wall 18, which is itself in electrical contact with the brass block 17. External earthing means are provided via the brass block by the earth connection 6. The zinc members 24 can also be provided with one or more O-rings 26 which can act to provide a water tight seal should it be required. In addition to providing sacrificial anode means within the conditioning device, these zinc members 24 can also aid in the precipitation of solids from the flow of fluid, as described below.

The embodiment of the water softening device 3 shown in FIGS. 3 and 4 comprises three zinc members 24 for the provision of three sets of sacrificial anode channels. The uppermost zinc member is provided with two separate O-rings 26 for the sealing of interface between the conditioning device 3 and the riser tube 1 while subsequent zinc members 24 are provided with only a single such O-ring 26. In construction, this arrangement eases the insertion of the riser tube 1 into the centre of the conditioning device 3.

The second type of channel contained within the conditioning device 3 has walls which are defined by holes bored through the dielectric members 27 in a manner analogous to the bore holes described for the zinc members 24. Two such members are provided in the embodiment shown in FIG. 4.

In the embodiment shown in FIG. 4, the zinc 24 and dielectric 27 channel defining members 27 are alternately positioned along the length of the conditioning device 3. Between adjacent pairs of channel defining members are positioned annularly shaped chambers 28 whose walls are defined by the end faces of the adjacent channel defining members and by either the inner surface of the brass block 17 or the inner surface of the inner annular wall 18 and by a protruding end member which protrudes annularly from the neighbouring dielectric channel defining member 27. The purpose of these chambers 28 is to promote or stimulate the turbulent flow of water within the device 3. This turbulent flow is further encouraged if, as suggested above, the channels of each channel defining member are deliberately misaligned with respect to those of neighbouring blocks, since this prevents fluid from taking a linear route through the conditioning device 3.

As described previously, the treatment assembly 10 has two modes of operation. When in normal filtering mode, fluid enters the conditioning device 3 from the control valve 8 via the inlet 11 and flows through a plurality of separate channels before passing on to the pressure vessel 2. During normal filtering, the conditioning device 3 performs the role of causing the precipitation and coagulation of dissolved compounds such as carbonates, ions and other colloids within the fluid flowing through it. It is thought that there are at least three effects which could stimulate such precipitation and coagulation within the device 3.

The first effect is thought to originate from an accumulation of static electricity which can take place at the surfaces of the dielectric channels as fluid flows over them. This in turn is thought to give rise to the precipitation of salts from the flow of fluid which can then act as nucleation sites for the precipitation of other materials. While this effect is not fully understood, it has been found that an increase in the surface area of the dielectric channels within a device 3 of this kind gives rise to an enhanced capability to stimulate precipitation and coagulation. It is for this reason that a number of separate channels are provided through the conditioning device since this increases the surface area of the dielectric used.

The second effect is thought to arise from the release of zinc oxide particles into the flow of fluid as a result of the sacrificial anode function of the zinc members 24. These particles can act as nucleation sites for the precipitation of other solids within the flow including carbonates of magnesium and calcium.

The third effect is thought to be caused by abrupt changes in fluid pressure which are encouraged within the conditioning device 3. These changes in pressure occur when the flow of fluid is divided into the plurality of channels provided within the channel defining members and also when the flow is recombined after exiting those channels. The turbulence chambers 28 described above perform the role of separating the channels formed in adjacent members, thereby allowing a number changes in pressure to occur as fluid flows through the conditioning device 3. In addition, the turbulent flow of fluid within these chambers 28 can lead to additional changes in pressure through the formation of small bubbles of any gases dissolved within the fluid.

These changes in pressure lead to changes in the solubility of solids dissolved within the fluid and can thereby lead precipitation of those solids. Again, these precipitates can act as nucleation sites for further precipitation.

It will be appreciated that further alternative embodiments can be envisaged.

Thus, for example, although in the described examples, the channels in the respective channel defining members are formed by bores, this need not be the case. In alternative embodiments the channels could be provided between vanes, or other structures forming channel defining members.

Also, although in the described embodiment, turbulence and cavitation in the water is stimulated by the relative positioning of the channels, in other embodiments specific structures e.g. ridges, discontinuities, etc., can be used to stimulate turbulence and cavitation.

In another embodiment of the present invention, the control valve 8 may be automatically operable using a timer or other timing means to automatically perform back-flushing at periodic intervals.

In another embodiment of the present invention, sensors may be used to monitor the pressure with which fluid exits the assembly. The control valve 8 may then be operable to perform back-flushing when the pressure drop across the assembly 10 has reached a predetermined level. In this manner, back-flushing would only be performed when it is deemed necessary.

In another embodiment, the assembly 10 may be duplexed in order that back flushing may be performed without halting the flow of fluids through the pipe network.

In other embodiments, other conditioning devices such as magnetic, electrolytic or electronic conditioners may be incorporated into a back-flushable filter.

In other embodiments, the means used for conditioning the fluid may be located within the filter bed itself. These means may comprise an arrangement of dielectric and/or metallic components arranged so as to promote precipitation. By arranging these means within the filter medium 13 itself, reabsorption of the precipitates can be further inhibited (in comparison to, for instance, the embodiment shown in FIG. 1 wherein reabsorption can take place while fluid flows between the conditioning device 3 and the filter media 13). Such an arrangement could also prevent layering of the filter medium 13 between back-flushing operations.

An application of the invention relates to the treatment of fluids such as beer or spirits. The invention enables the coagulation and subsequent removal by filtration of products of fermentation or destructive distillation from the fluid, which may otherwise give rise to unpleasant tastes and which take a long time to remove by traditional means such as storage over wood.

Another application of the invention relates to the maintenance of swimming pools, in particular to the removal of suspended proteins and cloudiness from the pool water. The filtration of the water to remove these colloids is difficult using normal filtration methods because of the small particle sizes involved. The invention enables the precipitation of the colloids resulting in larger average particle sizes. The colloids are subsequently removed from the water by the filter media. Similar considerations apply in the treatment of potable water supplies wherein the larger particle size produced by the fluid conditioning device also eases the filtration process.

A further application of the invention relates to the removal of dissolved substances such as iron compounds from water. The invention enables the precipitation of these compounds such that they can be removed from the water by the filter media. In these embodiments, the preferred filter medium comprises a conventional iron removal medium such as manganese green sand or BIRM.

What is claimed is:

1. A treatment apparatus for treating a fluid containing dissolved compounds, the treatment assembly comprising:
a fluid conditioning device operable to stimulate the precipitation of at least some of the dissolved compounds as precipitates;
a vessel containing a filter medium operable to trap said precipitates; and
a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium.

2. The treatment apparatus of claim 1, in which the fluid conditioning device is in fluid communication with a first portion of the vessel and a fluid conduit is in fluid communication with a second portion of the vessel.

3. The treatment apparatus of claim 2, wherein the first portion of the vessel is an upper region of the vessel and the second portion is a lower region of the vessel.

4. The treatment apparatus of claim 2, wherein the filter medium is contained at least in a region between the first and second portions of the vessel.

5. The treatment apparatus of claim 4, wherein the filter medium is denser than the fluid to be treated.

6. The treatment apparatus of claim 5, wherein the filter medium comprises sand.

7. The treatment apparatus of claim 5, wherein the filter medium comprises a conventional iron removal medium.

8. The treatment apparatus of claim 2, wherein the fluid conduit comprises a riser tube that extends from lower portion of the vessel to an opening in the vessel at an upper portion of the vessel.

9. The treatment apparatus of claim 8, wherein the riser tube has a spreader portion at a lower end thereof that provides fluid communication between the riser tube and the filter medium.

10. The treatment apparatus of claim 8, wherein the fluid treatment device has an annular cross-section and surrounds at least a part of the riser tube.

11. The treatment apparatus of claim 10, wherein the riser tube and the fluid treatment device extend through a common opening in the upper portion of the vessel.

12. The treatment apparatus of claim 1, wherein the fluid conditioning device comprises a plurality of channel defining members arranged sequentially between first and second ends of the fluid conditioning device, which channel defining members include at least one metallic channel defining member and at least one dielectric channel defining member, each channel defining member defining at least one channel; an inner annular wall; and an outer annular wall, the channel defining members being located within the inner annular wall, and an annular passage being defined between the inner annular wall and the outer annular wall, and the fluid conditioning device is configured to stimulate turbulence of the fluid when passing through said channels.

13. The treatment apparatus of claim 12, wherein the fluid conditioning device, in use, extends into the vessel, and the outer annular wall is operable to define a said end of the fluid conditioning device proximate to an upper end of the vessel.

14. The treatment apparatus of claim 8, or any claim dependent thereon, wherein the control valve is connected to an upper end of the riser tube and to the one end of the fluid conditioning device.

15. The treatment apparatus of claim 1, wherein the fluid comprises water.

16. The treatment apparatus of claim 6, wherein said compounds comprise iron compounds.

17. The treatment apparatus of claim 1, wherein said fluid conditioning device is further operable to stimulate the coagulation of colloids contained in said fluid, and wherein said colloids are filtered from said fluid by said filter medium.

18. A fluid conditioning device configured to be located around a tubular member, the fluid conditioning device comprises a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel, and the fluid conditioning device being configured to stimulate turbulence of the fluid when passing through said channels.

19. The fluid conditioning device of claim 18, wherein the fluid conditioning device further includes an earth connection for connection to an external electrical earth.

20. The fluid conditioning device of claim 19, wherein the fluid conditioning device further includes an inner annular wall and an outer annular wall, the channel defining members being located within the inner annular wall, and an annular passage being defined between the inner annular wall and the outer annular wall.

21. The fluid conditioning device of claim 20, wherein the inner and outer annular walls are electrically conductive and are electrically connected to each other.

22. The fluid conditioning device of claim 20, wherein the metallic channel defining members are electrically connected to the inner annular wall.

23. The fluid conditioning device of claim 20, wherein the inner and outer annular walls comprise of a first metal and the metallic channel defining members comprise a second metal that forms a sacrificial anode with respect to the first metal.

24. The fluid conditioning device of claim 19, wherein the metallic channel defining member comprises zinc and the dielectric channel defining member comprises PTFE.

25. The fluid conditioning device of claim 20, wherein at least some of the channel defining members are configured to stimulate turbulence.

26. A method of treating a fluid containing dissolved compounds, the method comprising:
passing the fluid through a fluid conditioning device operable to stimulate the precipitation of at least some of the dissolved compounds as precipitates;
trapping the precipitates in filter medium within a vessel; and
periodically back-flushing the filter medium to remove said precipitates from the filter medium.

27. The method of claim 26, wherein the filter medium is more dense than the fluid to be treated.

28. The treatment apparatus of claim 27, wherein the filter medium comprises sand.

29. The treatment apparatus of claim 27, wherein the filter medium comprises a conventional iron removal medium.

30. The method of claim 27, wherein the fluid comprises water.

31. A fluid conditioning device configured to be located around a tubular member, the fluid conditioning device comprising:
a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel;
electrically conductive inner and outer annular walls, which electrically conductive walls are electrically connected; and
an annular passage defined between the inner annular wall and the outer annular wall,
wherein the channel defining members are located within the inner annular wall, said metallic channel defining members are electrically connected to the inner annular wall, the inner and outer annular walls comprise of a first metal and the metallic channel defining members comprise a second metal that forms a sacrificial anode with respect to the first metal.

32. The fluid conditioning device of claim 31, wherein the metallic channel defining member comprises zinc and the dielectric channel defining member comprises PTFE.

33. The fluid conditioning device of claim 31, wherein at least some of the channel defining members are configured to stimulate turbulence.

34. The treatment apparatus of claim 31, wherein the fluid comprises water.

35. A fluid conditioning device configured to be located around a tubular member, the fluid conditioning device comprising:
a plurality of channel defining members arranged sequentially between first and second ends of the fluid conditioning device, which channel defining members include at least one metallic channel defining member and at least one dielectric channel defining member, each channel defining member having an annular form to fit around the tubular member and defining at least one channel, and the fluid conditioning device being configured to stimulate turbulence of the fluid when passing through said channels;
an inner annular wall;
an outer annular wall, the channel defining members being located within the inner annular wall; and
an annular passage defined between the inner annular wall and the outer annular wall,
wherein the inner and outer annular walls comprise of a first metal and the at least one metallic channel defining member comprises a second metal that forms a sacrificial anode with respect to the first metal, and least some of the channel defining members are configured to stimulate turbulence.

36. The fluid conditioning device of claim 35, wherein the metallic channel defining member comprises zinc and the dielectric channel defining member comprises PTFE.

37. The treatment apparatus of claim 35, wherein the fluid comprises water.

38. A treatment apparatus for treating a fluid containing dissolved compounds, the treatment assembly comprising:
a fluid conditioning device operable to stimulate the precipitation of at least some of the dissolved compounds as precipitates;
a vessel containing a filter medium operable to trap said precipitates;
a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium,
wherein said fluid conditioning device comprises:
a plurality of channel defining members arranged sequentially between first and second ends of said fluid conditioning device, which channel defining members include at least one metallic channel defining member and at least one dielectric channel defining member, each channel defining member defining at least one channel, said fluid conditioning device being configured to stimulate turbulence of the fluid when passing through said channels.

39. The treatment apparatus of claim 38, in which the fluid conditioning device is in fluid communication with a first portion of the vessel and a fluid conduit is in fluid communication with a second portion of the vessel.

40. The treatment apparatus of claim 39, wherein the first portion of the vessel is an upper region of the vessel and the second portion is a lower region of the vessel.

41. The treatment apparatus of claim 39, wherein the filter medium is contained at least in a region between the first and second portions of the vessel.

42. The treatment apparatus of claim 41, wherein the filter medium is denser than the fluid to be treated.

43. The treatment apparatus of claim 42, wherein the filter medium comprises sand.

44. The treatment apparatus of claim 42, wherein the filter medium comprises a conventional iron removal medium.

45. The treatment apparatus of claim 39, wherein the fluid conduit comprises a riser tube that extends from lower portion of the vessel to an opening in the vessel at an upper portion of the vessel.

46. The treatment apparatus of claim 45, wherein the riser tube has a spreader portion at a lower end thereof that provides fluid communication between the riser tube and the filter medium.

47. The treatment apparatus of claim 45, wherein the fluid treatment device has an annular cross-section and surrounds at least a part of the riser tube.

48. The treatment apparatus of claim 47, wherein the riser tube and the fluid treatment device extend through a common opening in the upper portion of the vessel.

49. A treatment apparatus for treating a fluid containing dissolved compounds, the treatment assembly comprising:
a fluid conditioning device, operable to stimulate the precipitation of at least some of the dissolved compounds as precipitates;
a vessel containing a filter medium operable to trap said precipitates;
a control valve in fluid communication with the fluid conditioning device and the filter medium, the control valve having a first operating mode in which fluid to be treated is passed via said fluid conditioning device into said filter medium, and a second mode in which the filter medium is back-flushed to remove said precipitates from the filter medium; and
a riser tube in fluid communication with a lower portion of said vessel, said riser tube extends said lower portion of the vessel to an opening in said vessel at an upper portion of the vessel,
wherein said fluid conditioning device is in fluid communication with an upper portion of said vessel.

50. The treatment apparatus of claim 49, wherein the filter medium is contained at least in a region between the first and second portions of the vessel.

51. The treatment apparatus of claim 50, wherein the filter medium is denser than the fluid to be treated.

52. The treatment apparatus of claim 51, wherein the filter medium comprises sand.

53. A fluid treatment device comprising:
a fluid conduit;
a fluid conditioning device configured to be mounted around said fluid conduit;
a cavity containing a filter medium; and
means for switchably directing a flow of fluid though said fluid treatment device according to either of two modes of operation,
wherein in the first mode of operation, said flow of fluid is directed through said fluid conditioning device whereby the precipitation of at least some dissolved compounds contained within said fluid is stimulated, the fluid then passes through said filter medium whereby said precipitates are removed from said flow of fluid, said fluid then passes out of said fluid treatment device through said fluid conduit, in the second mode of operation, the direction of fluid flow is substantially reversed whereby said filter medium is back-flushed to remove said precipitates from said filter medium.

54. Fluid conditioning means configured to be located around a tubular member, the fluid conditioning means comprising:
at least one metallic channel defining means, each defining at least one metallic channel;
at least one dielectric channel defining means each defining at least one dielectric channel;
the channel defining means have an annular form to fit around the tubular member and the channel defining means are arranged sequentially between first and second ends of the fluid conditioning means, the fluid conditioning means being configured to stimulate turbulence of the fluid when passing through said channels.

55. Fluid treatment means for treating a fluid containing dissolved compounds, comprising:
fluid conditioning means operable to stimulate the precipitation of at least some of the dissolved compounds as precipitates;
filter means operable to trap said precipitates; and
valve means operable to direct a flow of fluid through said means for treating a fluid according to either of two modes of operation,
wherein in said first mode of operation fluid to be treated is passed via said fluid conditioning means into said filter means, and in said second mode of operation, the direction of flow through said fluid treatment means is substantially reversed, thereby back-flushing said filter means to remove said precipitates therefrom.

56. A method for treating fluid containing dissolved compounds, the method comprising steps of:
stimulating turbulent flow in the fluid;
passing the fluid through a filter medium, whereby precipitates of the dissolved compounds present in the fluid are retained in the filter medium;
periodically flushing the filter medium whereby at least some of the precipitates retained in the filter medium are removed therefrom.

57. A method for treating fluid containing dissolved compounds, the method comprising steps of:
passing the fluid through one or more channels configured to stimulate the precipitation of the dissolved compounds;
passing the fluid through a filter medium, whereby at least some of the precipitates are retained in the filter medium;
periodically flushing the filter medium whereby at least some of the precipitates retained in the filter medium are removed therefrom.
